(19) United States
(12) Patent Application Publication
(10) Pub. No.: US 2025/0139423 A1
(43) Pub. Date: May 1, 2025

(54) OFFLOAD MULTI-DEPENDENT MACHINE LEARNING INFERENCES FROM A CENTRAL PROCESSING UNIT

(71) Applicant: DELL PRODUCTS L.P., Round Rock, TX (US)

(72) Inventors: Farzad Khosrowpour, Pflugerville, TX (US); Mitchell Markow, Hutto, TX (US)

(21) Appl. No.: 18/500,071

(22) Filed: Nov. 1, 2023

(51) Int. Cl. G06N 3/063

(52) U.S. Cl. CPC G06N 3/063

(57) ABSTRACT

An information handling system includes a central processing unit, a neural processing unit, and an offload module. The offload module receives an inference container including multiple inference models and metadata associated with the inference models. Based on the metadata, the offload module determines whether a quality of service for the inference models may be met by the neural processing unit. In response to the quality of service being met in the neural processing unit, the neural processing unit executes the inference models. In response to the quality of service not being met in the neural processing unit, the central processing unit executes the inference models.

### FIELD OF THE DISCLOSURE

The present disclosure generally relates to information handling systems, and more particularly relates to offloading multi-dependent machine learning inferences from a central processing unit in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a central processing unit, a neural processing unit, and an offload module. The offload module may receive an inference container including multiple inference models and metadata associated with the inference models. Based on the metadata, the offload module may determine whether a quality of service for the inference models may be met by the neural processing unit. In response to the quality of service being met by the neural processing unit, the neural processing unit may execute the inference models. In response to the quality of service not being met by the neural processing unit, the central processing unit may execute the inference models.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system according to at least one embodiment of the present disclosure;

FIG. 2 is a flow diagram of a method for offloading multi-dependent machine learning inferences in an information handling system according to at least one embodiment of the present disclosure;

FIG. 3 is a flow diagram of a method for performing a multi-dependent machine learning inference according to at least one embodiment of the present disclosure; and

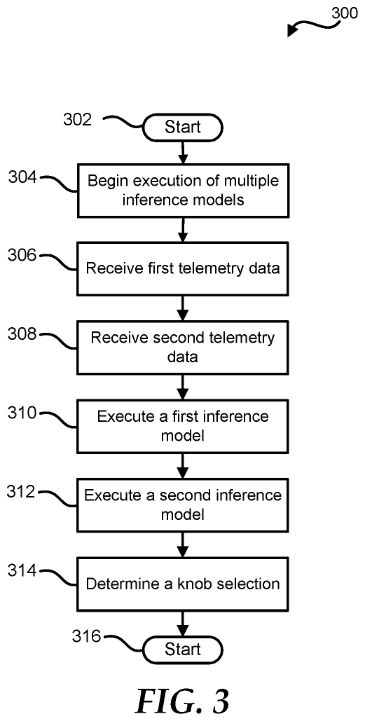

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

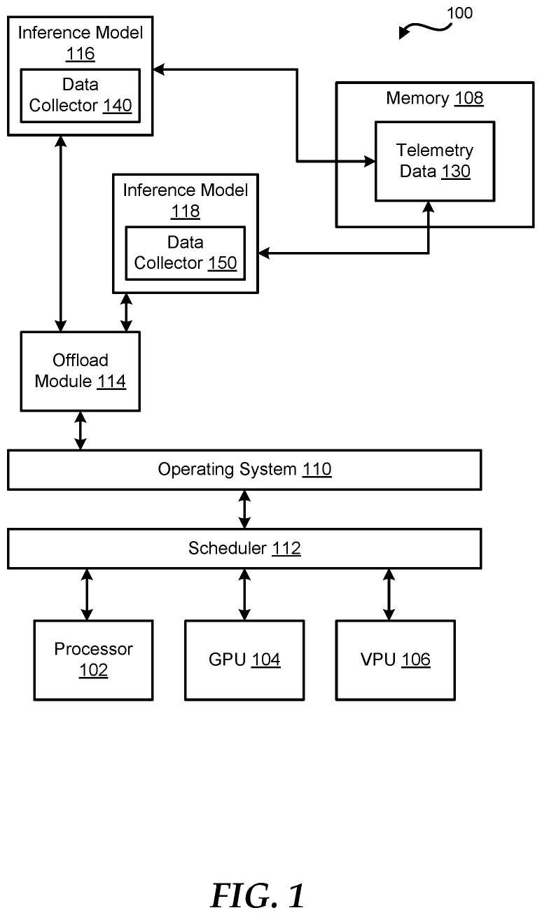

FIG. 1 illustrates an information handling systems according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a central processing unit (CPU) 102, a graphics processing unit (GPU) 104, a neural processing unit (NPU) 106, a memory 108, an operating system (OS) 110, a scheduler 112, an offload module 114, and multiple inference models 116 and 118. Memory 108 may store data associated with information handling system 100. The data in memory 108 may include, but is not limited to, telemetry data 130. In an example, telemetry data 130 may be collected and stored in memory by any suitable component of information handling system 100, such as a telemetry platform. Inference model 116 includes a data collector 140, and inference model 118 includes a data collector 150. NPU 106 is configured to run machine learning algorithms, such as convolutional neural networks (CNN), scale-invariant feature transform (SIFT), or the like. In certain examples, information handling system 100 may include any suitable number of inference models and each model may include a data collector. Information handling system 100 may include additional components without varying from the scope of this disclosure.

In an example, while OS 110, scheduler 112, and offload module 114 are illustrated as separate components of information handling system 100, these components may be different features of a single component. For example, scheduler 112 and offload module 114 may be extensions or features of OS 110. In this example, processor 102 may execute OS 110 and detect multiple machine learning (ML) inferences models, such as inference models 116 and 118, to be executed at substantially the same time. In certain examples, inference models 116 and 118 may be asynchronous, which may cause an indetermined impact on performance and power consumption in information handling system because these models may take CPU resources. In previous information handling systems, a runtime scheduler algorithm may also result in unpredictable timing outcome.

During operation of information handling system 100, scheduler 112 may be responsible for creating runtime distributions of data to inference models 116 and 118 that have been scheduled to run on an x-processing unit (xPU). In certain examples, xPU refers to any processing unit capable of executing inference models 116 and 118, such as processor 102, GPU 104 and NPU 106. In an example, inference models 116 and 118 may be interrelated and require a timing synchronization. For example, inference model 116 may detect stress level and usage in information handling system 100 and inference model 118 may detect applications utilization for a process. In an example, inference models 116 and 118 may run concurrently and have a time dependency. Previous information handling systems did not include timing synchronicity when scheduling inferences and data distribution. Additionally, when running models on different xPU from different vendors, the timing may be further impacted depending on the computation capability and other parameters. As such, software may result in different behavior of different systems.

Information handling system 100 may be improved via offload module 114 to prioritize workstreams based on the characteristics of the platform of information handling system 100 and customer use cases. Information handling system 100 may also be improved by offload module 114 determining whether multi-stream processes could be executed NPU 106 without involving the computation of processor 102. Another improvement of information handling system 100 may result from offload module 114 using xPU for the most effective usage for inter-dependent inferences to enable timing synchronization.

In an example, operations executed by offload module 114 made be performed in a processor, such as processor 102. For clarity and brevity, these operations will be referred to as being performed by offload module 114. In an example, offload module 114 may be an extension to OS 110. For example, offload module 114 may be an extension into the Open Vino libraries or similar of OS 110.

During operation, offload module 114 may recognize an inference container, which in turn may include one or more inference models, such as inference models 116 and 118. In an example, the inference container may also include additional metadata that includes the dependencies and priorities associated with inference models 116 and 118. In response to receiving the inference container, offload module 114 may determine a quality of service (QOS) for inference models 116 and 118. For example, the metadata QoS in the inference container may indicate that both inference models 116 and 118 should be executed within a particular time interval, identify a power performance level, latency, or the like. The metadata may also include dependencies between inference models 116 and 118. For example, the dependencies between inferences models 116 and 118 may define whether one of the inference models should be executed before the other inference model, or the like.

In an example, offload module 114 may communicate with scheduler 112 to determine what, if any, workloads are scheduled for processor 102, GPU 104, and NPU 106. Offload module 114 may analyze the metadata in the inference container to determine the QoS of inference models 116 and 118 and determine whether the QoS may be met based on any workloads already scheduled for processor 102, GPU 104, and NPU 106. Based on the QoS and schedule for NPU 106, offload module 114 may determine whether the NPU may complete the execution of inference models 116 and 118 in a particular time interval specified in the QoS. In an example, if NPU 106 may execute both inference models 116 and 118 and meet the QoS, offload module 114 may provide a schedule NPU request to scheduler 112. In response to the schedule NPU request, scheduler 112 may schedule inference models 116 and 118 for execution in NPU 106. In an example, the scheduling of inference models may include scheduling NPU 106 to execute data collectors 140 and 150 to retrieve telemetry data 130 from memory 108. Based on telemetry data 130, NPU 106 execute inference models 116 and 118 based on dependencies between the two models. Based on the outputs of inference models 116 and 118, NPU 106 may determine a control mechanism and configuration knob to apply in information handling system 100. In an example, the execution of the inference models 116 and 118 in NPU 106 may enable CPU 102 and GPU 104 to execution other operations or applications in information handling system 100.

In certain examples, if offload module 114 determines that NPU 106 may not execute both inference models 116 and 118 and meet the QoS, the offload module may automatically move the scheduling of the inferences to processor 102 or GPU 104. For example, offload module 114 may provide a schedule CPU request or schedule GPU request to scheduler 112. Based on these requests, scheduler 112 may schedule inference models 116 and 118 to be executed in the corresponding device, such as CPU 102 or GPU 104. In an example, CPU 102 and GPU 104 may execute inference models 116 and 118 in substantially the same manner as described above with respect to NPU 106. As described herein, offload module 114 may automatically determine

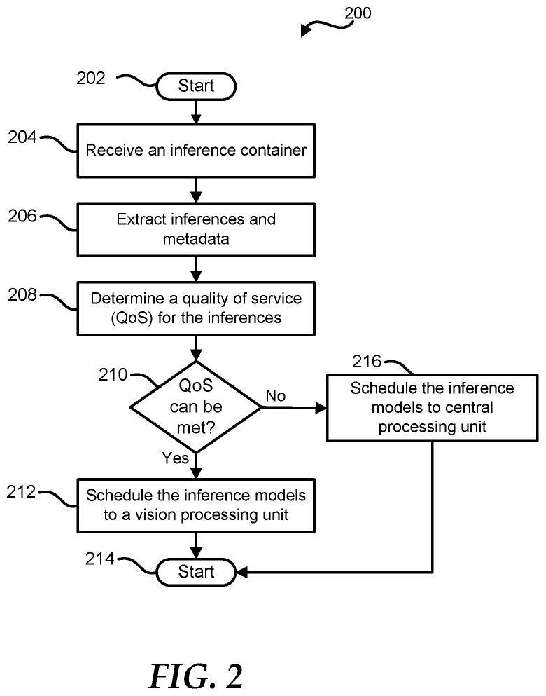

FIG. 2 is a flow diagram of a method 200 for offloading multi-dependent machine learning inferences in an information handling system according to at least one embodiment of the present disclosure, starting at block 202. In an example, method 200 may be performed by any suitable component including, but not limited to, processor 110 of FIG. 1. It will be readily appreciated that not every method step set forth in this flow diagram is always necessary, and that certain steps of the methods may be combined, performed simultaneously, in a different order, or perhaps omitted, without varying from the scope of the disclosure.

At block 204, an inference container is received. In an example, the inference container may be received by a processor, via an offload module, in an information handling system. The inference container may include multiple inference models to be executed within the information handling system. At block 206, the inference models and metadata are extracted from the inference container. In an example, the metadata may include a QoS for the inference models.

At block 208, a QOS of the inference models is determined. In an example, the QoS may be any suitable criteria that needs to be met during the operations of the inference models. For example, the QoS may include, but is not limited to, that the inference models should be executed within a particular time interval, identify a power performance level, and a latency. At block 210, a determination is made whether the QoS may be met by a NPU of the information handling system. In an example, the QoS of the inference models is analyzed with respect to a workload schedule for the NPU.

If the QOS may be met in the NPU, the inference models are scheduled in the NPU at block 212, and the flow ends at block 214. In an example, an offload module may provide a schedule NPU request to a scheduler, which in turn may schedule the inference models for execution in the NPU. If the QoS may be met in the NPU, the inference models are scheduled in a CPU or GPU at block 216, and the flow ends at block 214. In an example, the offload module may provide a schedule CPU request or a schedule GPU request to the scheduler, which in turn may schedule the inference models for execution in the CPU or GPU.

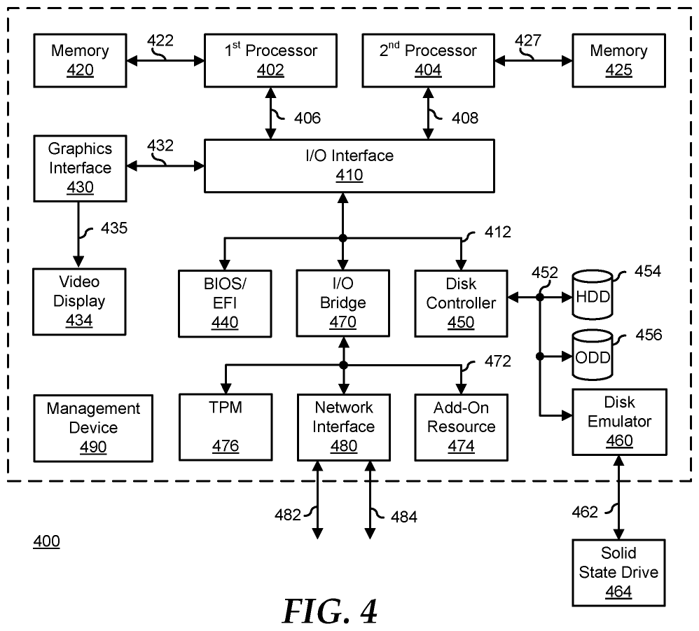

FIG. 4 is a flow diagram of a method 400 for determining an energy consumption for a process according to at least one embodiment of the present disclosure, starting at block 402. In an example, method 400 may be performed by any suitable component including, but not limited to, processor 110 of FIG. 1. It will be readily appreciated that not every method step set forth in this flow diagram is always necessary, and that certain steps of the methods may be combined, performed simultaneously, in a different order, or perhaps omitted, without varying from the scope of the disclosure.

At block 304, execution of multiple inference models is begun. In an example, the inference models may be executed in a NPU, a CPU, or a GPU. At block 306, first telemetry data is received. In an example, the first telemetry data may be received by a data collector of a first inference model. The first telemetry data may be system stress detection data. At block 308, second telemetry data is received. In an example, the second telemetry data may be received by a data collector of a second inference model. The second telemetry data may be application classification data.

At block 310, the first inference model is executed based on the first telemetry data. In an example, the first inference model may be a system stress detection inference model. At block 312, the second inference model is executed based on the second telemetry data. In an example, the second inference model may be application classification inference model. At block 314, a configuration knob selection is determined, and the flow ends at block 316.

FIG. 4 shows a generalized embodiment of an information handling system 400 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 462, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 462, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a central processing unit;
a neural processing unit; and
an offload module to communicate with the central processing unit and with the neural processing unit, the offload module to:
receive an inference container including multiple inference models and metadata associated with the inference models; and
based on the metadata, determine whether a quality of service for the inference models may be met by the neural processing unit;
in response to the quality of service being met by the neural processing unit, the neural processing unit to execute the inference models; and
in response to the quality of service not being met by the neural processing unit, the central processing unit to execute the inference models.

2. The information handling system of claim 1, wherein the information handling system further comprises a scheduler in communication with the offload module, wherein prior to the execution of the inference models in the neural processing unit, the scheduler to:
receive a schedule neural processing unit request from the offload module; and
in response to the schedule neural processing unit request, schedule the inference models for execution in the neural processing unit.

3. The information handling system of claim 1, wherein the information handling system further comprises a scheduler in communication with the offload module, wherein prior to the execution of the inference models in the central processing unit, the scheduler to:
receive a schedule central processing unit request from the offload module; and
in response to the schedule central processing unit request, schedule the inference models for execution in the central processing unit.

4. The information handling system of claim 1, further comprising a memory to store telemetry data associated with the information handling system.

5. The information handling system of claim 4, wherein the execution of the inference models by the neural processing unit includes the neural processing unit to provide the telemetry data as an input to the inference models.

6. The information handling system of claim 1, wherein the offload module is an extension to an operating system of the information handling system.

7. The information handling system of claim 1, the execution of the inference models in the neural processing unit enables the central processing unit to perform other operations.

8. The information handling system of claim 1, wherein the quality of service indicates a particular time interval for execution of the inference models, a power performance level, and a latency.

9. A method comprising:
receiving, by an offload module of an information handling system, an inference container including multiple inference models and metadata associated with the inference models;
based on the metadata, determining whether a quality of service for the inference models may be met by a neural processing unit of the information handling system;
in response to the quality of service being met in the neural processing unit, the neural processing unit to execute the inference models; and
in response to the quality of service not being met in the neural processing unit, a central processing unit or a graphics processing unit of the information handling system to execute the inference models.

10. The method of claim 9, wherein prior to the executing of the inference models in the neural processing unit, the method further comprises:
receiving, by a scheduler of the information handling system, a schedule neural processing unit request from the offload module; and
in response to the schedule neural processing unit request, scheduling the inference models for execution in the neural processing unit.

11. The method of claim 9, wherein prior to the executing of the inference models in the neural processing unit, the method further comprises:
receiving, by a scheduler of the information handling system, a schedule central processing unit request from the offload module; and
in response to the schedule central processing unit request, scheduling the inference models for execution in the central processing unit.

12. The method of claim 9, further comprising storing, in a memory of the information handling system, telemetry data associated with the information handling system.

13. The method of claim 12, wherein the executing of the inference models by the neural processing unit, the method further comprises: providing, by the neural processing unit, the telemetry data as an input to the inference models.

14. The method of claim 9, wherein the offload module is an extension to an operating system of the information handling system.

15. The method of claim 9, further comprising: based on the execution of the inference models in the neural processing unit, enabling the central processing unit to perform other operations.

16. The method of claim 9, wherein the quality of service indicates a particular time interval for execution of the inference models, a power performance level, and a latency.

17. A method comprising:
receiving, by an offload module of an information handling system, an inference container including multiple inference models and metadata associated with the inference models;
based on the metadata, determining whether a quality of service for the inference models may be met by a neural processing unit of the information handling system;
if the quality of service is met in the neural processing unit, then:
providing a schedule neural processing unit request to a scheduler of the information handling system;
scheduling, by the scheduler, the inference models for execution in the neural processing unit to execute the inference models; and
executing, by the neural processing unit, the inference models; and
if the quality of service is not met in the neural processing unit, then:
providing a schedule central processing unit request to a scheduler of the information handling system;
scheduling, by the scheduler, the inference models for execution in the central processing unit to execute the inference models; and
executing, by the central processing unit, the inference models.

18. The method of claim 17, wherein the offload module is an extension to an operating system of the information handling system.

19. The method of claim 17, wherein the executing of the inference models by the neural processing unit, the method further comprises providing, by the neural processing unit, the telemetry data as an input to the inference models.

20. The method of claim 17, further comprising based on the execution of the inference models in the neural processing unit, enabling the central processing unit to perform other operations.
